(19) United States
(12) Patent Application Publication
(10) Pub. No.: US 2026/0295452 A1
(43) Pub. Date: Oct. 1, 2026

(54) GEOMETRIC ART TOY DEVICE

(71) Applicant: Andreas Hoenigschmid, Los Angeles, CA (US)

(72) Inventor: Andreas Hoenigschmid, Los Angeles, CA (US)

(21) Appl. No.: 19/480,781

(22) PCT Filed: Apr. 26, 2024
(86) PCT No.: PCT/US2024/026681

§ 371 Date: Oct. 31, 2025

Related U.S. Application Data
(60) Provisional application No. 63/463,279, filed on May 1, 2023.

(51) Int. Cl. A63H 33/04; A63F 9/08

(52) U.S. Cl. CPC A63H 33/046; A63F 9/088

(57) ABSTRACT

A geometric art toy device has a set of sixteen tetrahedron-shaped bodies that are linked together by hinge connections. Each of the bodies has an edge E defining a longest-length edge of the tetrahedron-shaped body, a base surface defining a first base edge B and a hypotenuse edge B′, and a first side surface defining a further edge H and a second further edge S of the tetrahedron-shaped body. The hinge connections include a first hinge connection along the first base edge B of the base of each of the bodies, and a second hinge connection along the edge E of each of the bodies. Each tetrahedron-shaped body has the dimensions such as: H=√2, E=2, S=√3, B=1, and B′=√2.

### CLAIM OF BENEFIT TO PRIORITY APPLICATION

This application claims priority to U.S. Patent Application No. 63/463,279, filed May 1, 2023, the full disclosure of which is incorporated herein in its entirety.

### FIELD OF THE DISCLOSURE

The present disclosure relates to geometric art toy devices that can provide a stimulating puzzle experience, a three-dimensional piece of art, or a combination thereof. In some examples, multiple geometric art toy devices as described herein can be used together as a further stimulating puzzle experience, a further three-dimensional piece of art, or a combination thereof.

### BACKGROUND

Geometric art toy devices described herein are composed of a plurality of (or a set of) three-dimensional bodies (also referred to as puzzle pieces) of certain dimensions and shapes, that are connected together by hinge connections. The hinge-connected puzzle pieces in a given set may be manually moved about the hinge connections to positions in which the set of puzzle pieces form various substantially symmetrical or non-symmetrical, three-dimensional structures. A substantially symmetrical configuration is a configuration that is substantially symmetrical about one or more axis that extend through a center of the geometric configuration.

At least some of the hinge-connected puzzle pieces include one or more magnets that stably hold (by magnetic force) the puzzle pieces of the set together in one or more (or a plurality of) possible three-dimensional structures. The orientation, location and pole arrangement of the magnets enables the set of bodies (or puzzle pieces) to be held together (by magnetic force) in the one or more possible three-dimensional structures. In various contexts, the geometric art toy device (or a combination of multiple geometric art toy devices) may be used as a mind-stimulating puzzle toy, an educational device, a design tool, a form of art, or any combination thereof.

Embodiments of geometric art toy devices described herein relate, generally, to three-dimensional geometric art toys described in U.S. Pat. No. 10,569,185, which is incorporated herein by reference, in its entirety. However, embodiments described herein differ from the examples described in that patent, at least in regard to unique combinations of shapes, dimensions and location of hinge connections, as well as other aspects described herein, that enable each set puzzle pieces to be assembled into an octahedron having eight, triangular faces resembling a diamond-like shape. An octahedron defining a diamond-shaped structure can have a pleasing, aesthetically attractive and striking quality relative to simple cube or rectangle shapes. In particular embodiments described herein, multiple sets of puzzle pieces can be combined to form one or more further generally symmetrical structures.

### BRIEF DESCRIPTION OF THE DRAWINGS

FIG. 1 is a perspective view of a geometric art toy device configured in a three-dimensional diamond-shaped structure and formed of a set of hinge-connected, three-dimensional bodies (or puzzle pieces).

FIG. 2 is a perspective view of a mirror image pair of three-dimensional bodies (or puzzle pieces) in the set of FIG. 1.

FIGS. 3a and 3b are sheet patterns corresponding to the mirror image pair of three-dimensional bodies of FIG. 2.

FIG. 4 is a schematic diagram representing four mirror image pairs of three dimensional bodies of FIG. 2, with hinge-connected edges identified by horizontal lines.

FIG. 5 is a perspective view of a set of hinge-connected, three-dimensional bodies (or puzzle pieces) for an example geometric art toy device.

FIG. 6 is another perspective view of the same set of hinge-connected, three-dimensional bodies (or puzzle pieces) of FIG. 5, but from a different perspective angle.

FIG. 7 is another perspective view of the same set of hinge-connected, three-dimensional bodies (or puzzle pieces) of FIGS. 5 and 6, but from a different perspective angle.

FIG. 8a is a diagram showing a perspective view and side views of another example of a geometric art toy device configured in a three-dimensional diamond-shaped structure and formed of a set of hinge-connected, three-dimensional bodies (or puzzle pieces).

FIGS. 8b and 8c are sheet patterns corresponding to the mirror image pair of three-dimensional bodies of FIG. 8a.

FIG. 9a is a diagram showing a perspective view and side views of another example of a geometric art toy device configured in a three-dimensional diamond-shaped structure and formed of a set of hinge-connected, three-dimensional bodies (or puzzle pieces).

FIGS. 9b and 9c are sheet patterns corresponding to the mirror image pair of three-dimensional bodies of FIG. 9a.

FIG. 10a is a diagram showing a perspective view and side views of another example of a geometric art toy device configured in a three-dimensional diamond-shaped structure and formed of a set of hinge-connected, three-dimensional bodies (or puzzle pieces).

FIGS. 10b and 10c are sheet patterns corresponding to the mirror image pair of three-dimensional bodies of FIG. 10a.

FIG. 11a is a diagram showing a perspective view and side views of another example of a geometric art toy device configured in a three-dimensional diamond-shaped structure and formed of a set of hinge-connected, three-dimensional bodies (or puzzle pieces).

FIGS. 11b and 11c are sheet patterns corresponding to the mirror image pair of three-dimensional bodies of FIG. 11a.

FIG. 12a is a diagram showing a perspective view and side views of another example of a geometric art toy device configured in a three-dimensional diamond-shaped structure and formed of a set of hinge-connected, three-dimensional bodies (or puzzle pieces).

FIGS. 12b and 12c are sheet patterns corresponding to the mirror image pair of three-dimensional bodies of FIG. 12a.

FIG. 13a is a diagram showing a perspective view and side views of another example of a geometric art toy device configured in a three-dimensional diamond-shaped structure and formed of a set of hinge-connected, three-dimensional bodies (or puzzle pieces).

FIGS. 13b and 13c are sheet patterns corresponding to the mirror image pair of three-dimensional bodies of FIG. 13a.

### DETAILED DESCRIPTION

The present disclosure relates to geometric art or toy devices and, in some examples, to a kit of multiple geometric art or toy devices as described herein that can be used together. In particular examples, the geometric art or toy device (also referred to herein as geometric art toy device) or the kit of devices can provide a stimulating puzzle experience, a three-dimensional piece of art, or a combination thereof.

Hereinafter, example embodiments will be described in more detail with reference to the accompanying drawings. The present invention, however, may be embodied in various different forms, and should not be construed as being limited to only the illustrated embodiments herein. Rather, these embodiments are provided as examples so that this disclosure will be thorough and complete, and will fully convey the aspects and features of the present invention to those skilled in the art. Accordingly, processes, elements, and techniques that are not necessary to those having ordinary skill in the art for a complete understanding of the aspects and features of the present invention may not be described. Unless otherwise noted, like reference numerals denote like elements throughout the attached drawings and the written description, and thus, descriptions thereof may not be repeated. Further, features or aspects within each example embodiment should typically be considered as available for other similar features or aspects in other example embodiments.

In the drawings, the relative sizes of elements, layers, and regions may be exaggerated and/or simplified for clarity. Spatially relative terms, such as “beneath,” “below,” “lower,” “under,” “above,” “upper,” “front” and “rear” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present invention.

It will be understood that when an element or layer is referred to as being “on,” “connected to,” or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments and is not intended to be limiting of the present invention. As used herein, the singular forms “a” and “an” are intended to include the plural forms as well, unless the context clearly indicates otherwise. It will be further understood that the terms “comprises,” “comprising,” “includes,” and “including,” “has,” “have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively. Also, the term “exemplary” is intended to refer to an example or illustration.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

In particular examples described herein, a single geometric art toy device includes a set of sixteen bodies (or puzzle pieces) that are linked together by hinge connections. The hinge-connected bodies (or puzzle pieces) may be manually movable about the hinge connections to positions in which the set of bodies (or puzzle pieces) form various substantially symmetrical or non-symmetrical, three-dimensional structures.

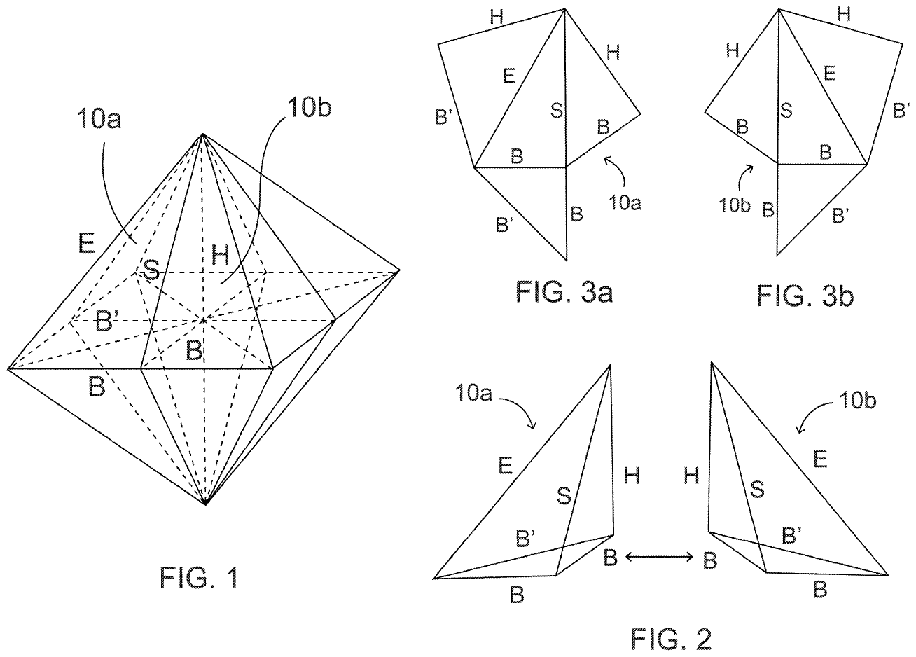

The sizes and dimensions of the three-dimensional structures that may be formed by a given set of bodies (or puzzle pieces) will depend upon the size and dimension of each of the bodies (or puzzle pieces), as well as the hinge position on each of the bodies (or puzzle pieces). However, examples described herein are configured to form and hold an eight-sided octahedron having a diamond shape structure (among other possible structure shapes), when the set of sixteen bodies are moved about the hinge connections to particular positions. While the size and dimensions of the eight-sided diamond shape structure may differ among different embodiments, one example of a geometric art toy device 10 in which the sixteen bodies (or puzzle pieces) are in positions to form an octahedron having a diamond shape structure is shown in FIG. 1.

In FIG. 1, two of the sixteen bodies (or puzzle pieces) are identified as body 10a and body 10b. While reference characters in FIG. 1 are included only on the body 10a, each of the sixteen bodies in the device 10 has a base defining a right triangle having a right angle between two of the base edges B, and a hypotenuse base edge B′. Each of the bodies has a height edge H, and two side edges S and E.

Each of the sixteen bodies (or puzzle pieces) in the set has a three-dimensional shape of a tetrahedron-shaped pyramid, with a base shaped as a right triangle, and with three triangle-shaped sides. A tetrahedron is a polygonal solid figure having six edges and four triangular surfaces, three of which meet at each of four corners or vertices. In examples described herein, each body (or puzzle piece) in a given set is identical in shape and size to each of the other bodies (or puzzle pieces) in the same set, but faces opposite (as a mirror image) of each adjacent-connected puzzle pieces in the set.

The two bodies (or puzzle pieces) 10a and 10b of a geometric art toy device 10 are shown in FIG. 2. The bodies 10a and 10b in FIG. 2 are a mirror image pair of bodies. The set of sixteen bodies of the geometric art toy device 10 includes eight such pairs of bodies that may be identical to the pair of bodies 10a and 10b in FIG. 2. Each of the bodies 10a and 10b in FIG. 2 may be a hollow body, a solid body, a filled or partially filled body, a wire or other framework body, or the like, defining an outer dimension and shape as shown. Each of the bodies 10 may be made of any suitable material including, but not limited to plastic, paper, paperboard, ceramic, wood, metal, combinations thereof, or the like, and is rigid or sufficiently rigid to hold its shape without external support. In certain examples, each of the bodies 10a and 10b is formed from a sheet material that is cut or formed in a pattern as shown in FIGS. 3a and 3b, and then folded along the internal edges B, S and E to form the three-dimensional bodies shown in FIG. 2. In some embodiments, one or more (or all) of the bodies (or puzzle pieces) in a given set include a design or indicia on one or more (or all) of its outward-facing surfaces.

In the example embodiment of FIG. 1, the bodies 10a and 10b are connected to each other by a hinge connection along an edge B of each of the bodies (i.e., the edge B that directly extends from the edge H). The hinge connection may include any suitable hinge or pivot structure that connects the edges B of the two bodies 10a and 10b, yet allows the bodies 10a and 10b to pivot about an axis along the connected edges B. The hinge connection may be formed of any suitable hinge structure or flexible material such as, but not limited to flexible tape, vinyl stickers or other flexible adhesives.

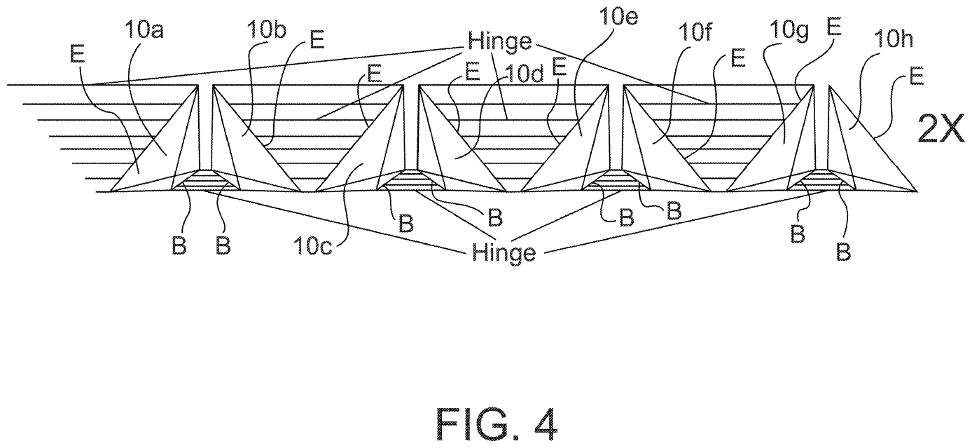

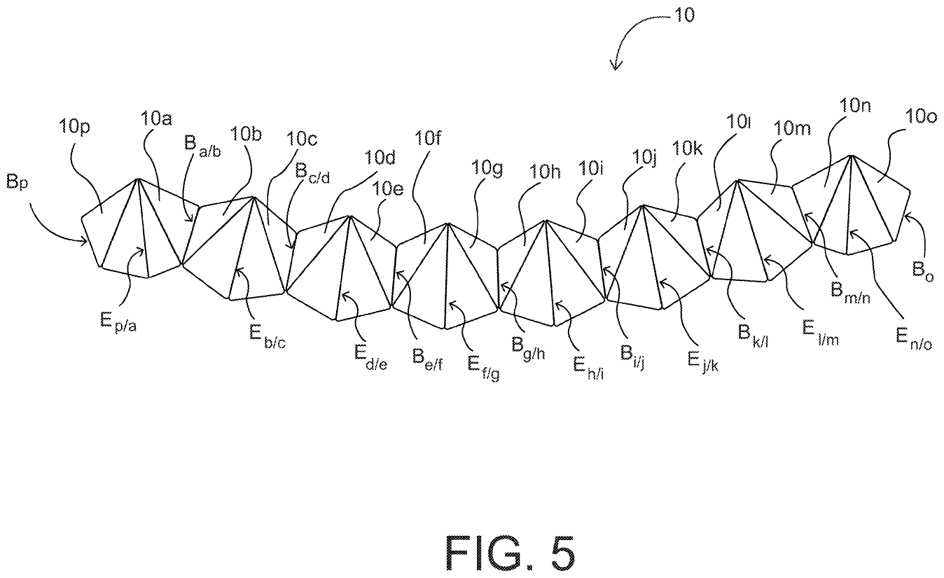

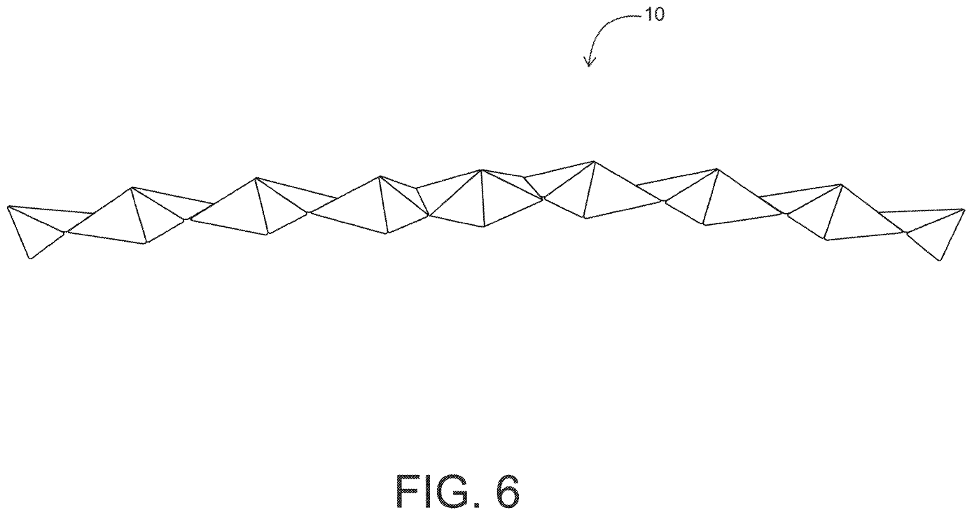

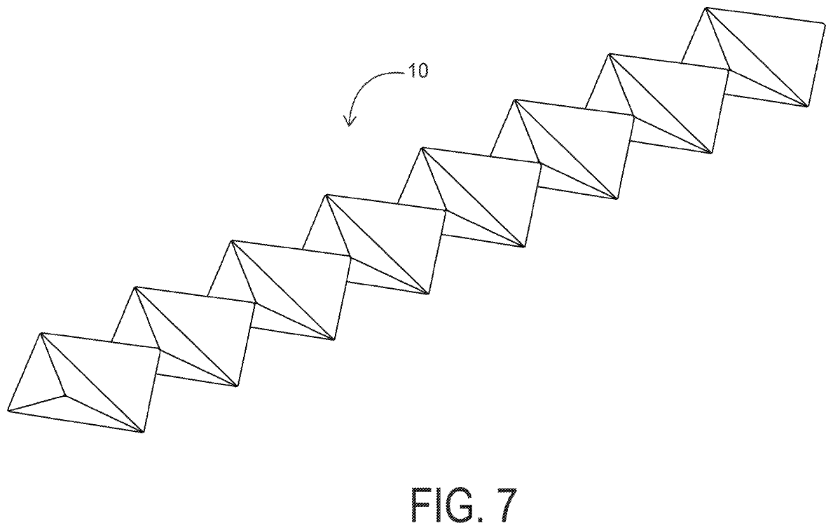

In addition, each of the bodies 10a and 10b in FIG. 1 is connected to an adjacent body of a similar pair of bodies along the side edge E of the body 10a or 10b, by a hinge connection as described herein. To help explain the hinge connections, FIG. 4 shows four pairs of bodies (i.e., eight bodies 10a-10h) of the set of sixteen bodies that form the geometric art toy device of FIG. 1. The horizontal lines in FIG. 4 identify the edges of the bodies 10a-10h that are hinge connected, as described herein. As shown in FIG. 4, the bodies 10a and 10b are hinge connected at edges B, the bodies 10b and 10c are hinge connected at edges E, the bodies 10c and 10d are hinge connected at edges B and so forth. FIG. 4 only shows eight of the sixteen bodies that form the structure in FIG. 1. Accordingly, the structure in FIG. 1 includes another eight bodies (10i-10p) similar to the bodies 10a-10h and connected to the edges E of the bodies 10a and 10h, as shown in FIGS. 5-7. While not shown in FIGS. 5-7, the edge B_{O} and B_{P} are also hinge connected together. Other edge of the bodies 10a-10p are not connected to each other. The set of sixteen hinge-connected bodies (or puzzle pieces) forms a ring of bodies (or puzzle pieces) that can be manually moved about the hinge connections to form three-dimensional structures, including the structure shown in FIG. 1.

FIGS. 5-7 show different view angles of an example of a complete set of sixteen tetrahedron-shaped bodies (or puzzle pieces), connected or linked by hinge connections along an edge B and an edge E of each of the bodies. Because they are linked together in the manner represented in that drawing, the sixteen tetrahedron-shaped bodies (or puzzle pieces) of a given geometric art toy device can be pivoted relative to each other to form an octahedron having a diamond shape, such as represented by the drawing in FIG. 1. The same linked set of tetrahedron-shaped bodies (or puzzle pieces) can be manipulated about the hinge connections in other manners to form other three-dimensional shapes. In some examples, the dimensions of each tetrahedron-shaped body (or puzzle piece) are selected to enable the linked set to form at least one other symmetrical, three-dimensional shape.

In the example in FIGS. 5-7, some of the tetrahedron-shaped bodies (or puzzle pieces) have edge labels corresponding to those used in FIGS. 1-4, but with subscripts. For example, the edges labeled Ba/b in FIG. 1 corresponds to the hinge connected edges B of the two tetrahedron-shaped bodies (or puzzle pieces) 10a and 10b. Similarly, edges labeled Eb/c in FIGS. 5-7 corresponds to the hinge connected edges E of the two tetrahedron-shaped bodies (or puzzle pieces) 10b and 10c, and so forth. The rest of the sixteen tetrahedron-shaped bodies (or puzzle pieces) in the set are hinge connected at corresponding edges. In addition, the edge labeled B_{O} of the body (or puzzle piece) 10o is hinge connected to the edge Bₚ of the body (or puzzle piece) 10p, but is shown separated in FIGS. 5-7, to better illustrate the hinge connections in the complete set of tetrahedron-shaped bodies (or puzzle piece).

The hinge connections enable pivotal movement between the hinge-connected bodies (or puzzle pieces). During use of the geometric art toy device, a user may quickly and easily move the individual bodies (or puzzle pieces) of the device relative to one another, about the hinge connections, to form the device into any one of multiple possible configurations. At least some of the bodies (or puzzle pieces) include magnets that are arranged to hold (by magnetic attraction) the set of sixteen bodies (or puzzle pieces) in one or more (or a plurality of optional) three-dimensional structure forms, including the octahedron or diamond shape form shown in FIG. 1.

In some examples, the magnets may be arranged in adjacent bodies in the manner as described in U.S. Pat. No. 10,569,185, cited above. In other examples, the bodies (or puzzle pieces) may have other suitable arrangements of magnets. The positioning, orientation and polarity of the magnets within each of the bodies (or puzzle pieces) enables the device to be stably maintained in any user-selected one of the multiple possible configurations, including the octahedron or diamond shape forms described herein.

In certain embodiments, in addition to enabling the formation of an octahedron having eight, triangular faces resembling a diamond-like shape, the hinge-connected bodies (or puzzle pieces) of a given set may be moved about the hinge connections to form one or more other three dimensional structures having other shapes. In particular embodiments, at least one of those other three dimensional structures has a symmetrical shape. In further particular embodiments, in addition to enabling the formation of a first octahedron, the hinge-connected bodies (or puzzle pieces) of a given set may be moved about the hinge connections to form a second, identical octahedron, but with different faces of each of the hinge-connected bodies (or puzzle pieces) facing outward relative to the first octahedron.

In particular embodiments, three or more sets of hinge-connected bodies (or puzzle pieces) may each be arranged in another three-dimensional structure having a symmetrical shape, and then arranged together to form various other, larger geometric configurations, including at least one substantially symmetrical configuration that is substantially symmetrical about one or more axis that extend through a center of the geometric configuration. The number of geometric art toy devices that are capable of forming a substantially symmetrical structure depends upon the relative lengths of the sides of the tetrahedron-shaped bodies (or puzzle pieces) of the geometric art toy devices. Accordingly, it can also be said that the number of geometric art toy devices that are capable of forming a substantially symmetrical structure depends upon the relative angles between the sides of the tetrahedron-shaped bodies (or puzzle pieces) of the geometric art toy devices. That relationship is expressed in Table 1, below.

TABLE 1

| | | | | | | |
|---|---|---|---|---|---|---|
| Symmetry | 3 | 4 | Diamond | 5 | 6 | 8 |
| Internal Angle | 60 | 45 | 35.264 | 36 | 30 | 22.5 |
| Height H | square | 1 | square | 1.37638 | square | 1 + square |
| | root of 1/3 | | root of 2 | | root of 3 | root of 2 |
| Edge E | square | square | 2 | 1.97343 | square | square |
| | root of 7/3 | root of 3 | | | root of 5 | root of (4 + |
| | | | | | | 2 × square |
| | | | | | | root of 2) |
| Edge S | square | | square | 1.7013 | 2 | square |
| | root of 4/3 | | root of 3 | | | root of (5 + |
| | | | | | | 2 × square |
| | | | | | | root of 2) |
| Base B | 1 | 1 | 1 | 1 | 1 | 1 |
| Baseroot B′ | square | square | square | square | square | square |
| | root of 2 | root of 2 | root of 2 | root of 2 | root of 2 | root of 2 |

More specifically, in Table 1, each of the second through seventh column represents an example embodiment of a geometric art toy device having sixteen bodies as described herein, but with the dimensions shown in the second through seventh rows of the table. Table 1 includes a first row labeled “Symmetry” that indicates the minimum number of the 16-piece geometric art toy devices that can connect together to form a larger, substantially symmetrical structure. The next rows of the chart indicate the size of the internal angle and the relative lengths of the sides of each of the sixteen tetrahedron-shaped bodies (or puzzle pieces). The relative lengths of the sides of the tetrahedron-shaped bodies (or puzzle pieces) are expressed in the table as unit lengths, where the actual length of one (1) unit may be any selected length such as, but not limited to any unit length about 2-4 inches for a device size suitable for holding by hand.

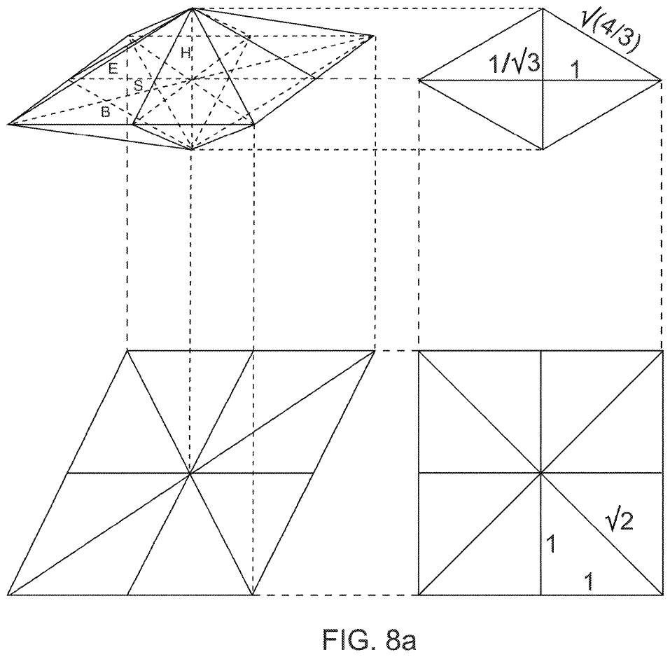

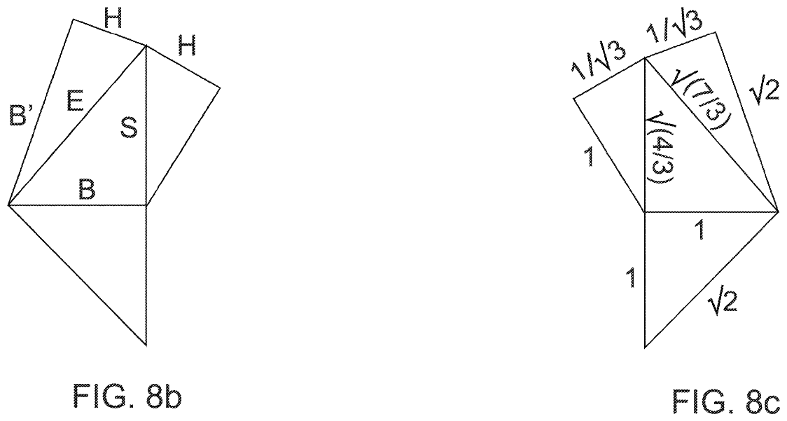

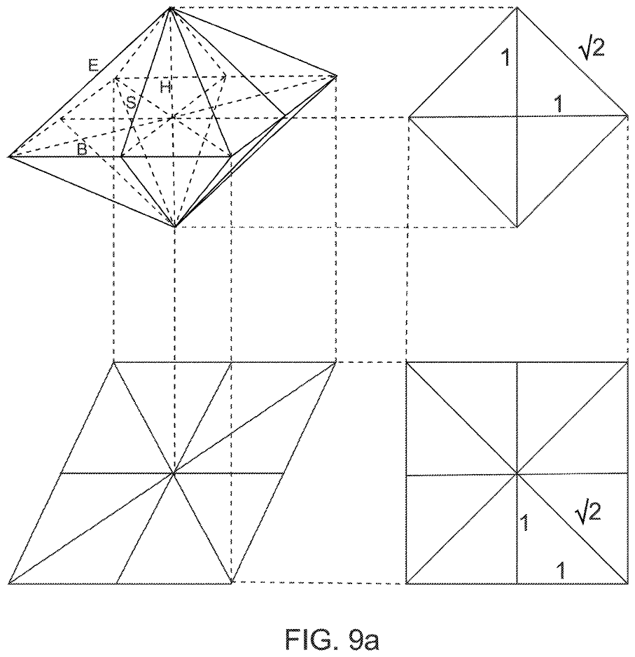

In Table 1, the column having the Symmetry “3” corresponds to an embodiment as shown in FIGS. 8a and 8b, in which the bodies (or puzzle pieces) of a single 16-body geometric art toy device can be pivoted to form an octahedron having a substantially diamond shape with a flattened-diamond appearance (relative to the shape in FIG. 1). FIG. 8a shows a diagram representing the three-dimensional diamond shape, as well as a side view and a top-down (or bottom up) view of the three-dimensional diamond shape, with indica representing the size dimensions of certain body edges. FIG. 8b shows a sheet pattern of a body (or puzzle piece) of the example in FIG. 8a, where the example in FIG. 8a includes sixteen bodies (or puzzle pieces) composed of eight mirror image pairs of bodies (or puzzle pieces), each body having the configuration, or a mirror image of the configuration, shown in FIG. 8b. With the Symmetry “3” configuration of FIGS. 8a and 8b, three of those same 16-piece geometric art toy devices can connect together to form a larger, substantially symmetrical structure.

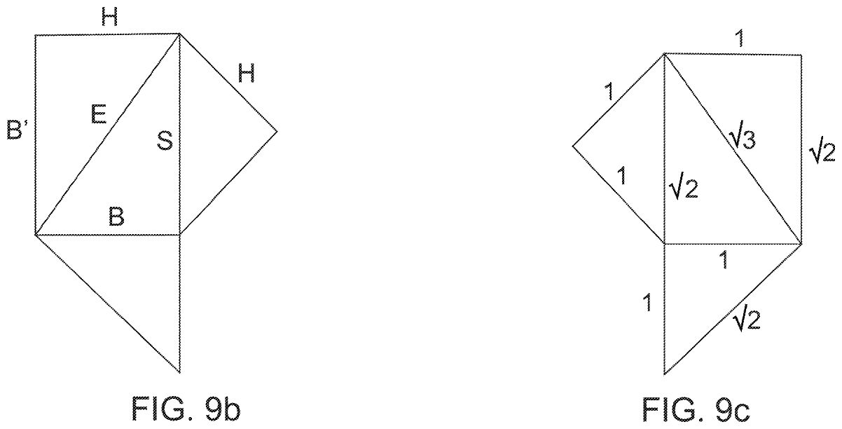

In Table 1, the column having the Symmetry “4” corresponds to an embodiment in which the bodies (or puzzle-pieces) of a single 16-body geometric art toy device can be pivoted to form an octahedron having a substantially diamond shape with an appearance as shown in FIGS. 9a and 9b, and in which four of those same 16-body geometric art toy devices can connect together to form a larger, substantially symmetrical structure. In addition, the Symmetry “4” embodiment is able to form a first octahedron (or diamond) shape with the sixteen bodies (or puzzle pieces) oriented in a first direction, and to form a full inversion of the sixteen bodies (or puzzle pieces) to form an identical, second octahedron (or diamond) shape, but with completely different faces of the respective bodies (or puzzle pieces) facing outward relative to the first octahedron.

FIG. 9a shows a diagram representing the three-dimensional diamond shape, as well as a side view and a top-down (or bottom up) view of the three-dimensional diamond shape, with indica representing the size dimensions of certain body edges. FIG. 9b shows a sheet pattern of a body (or puzzle piece) of the example in FIG. 9a, where the example in FIG. 9a includes sixteen bodies (or puzzle pieces) composed of eight mirror image pairs of bodies (or puzzle pieces), each body having the configuration, or a mirror image of the configuration, shown in FIG. 9b.

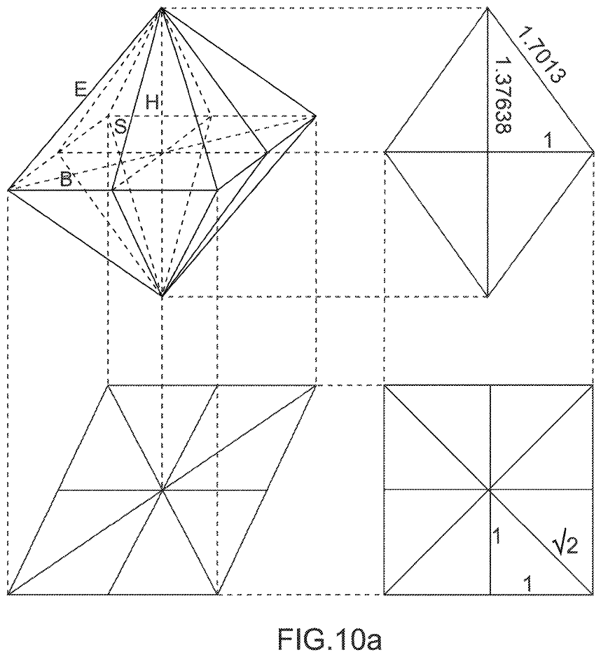

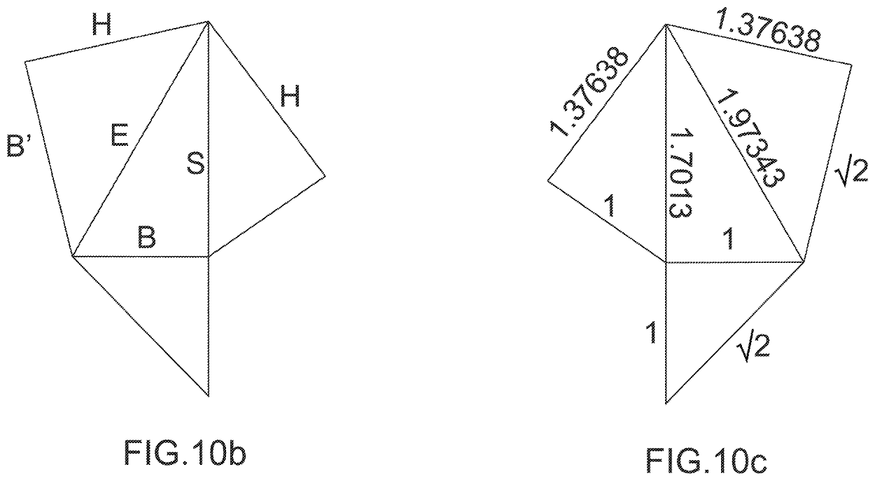

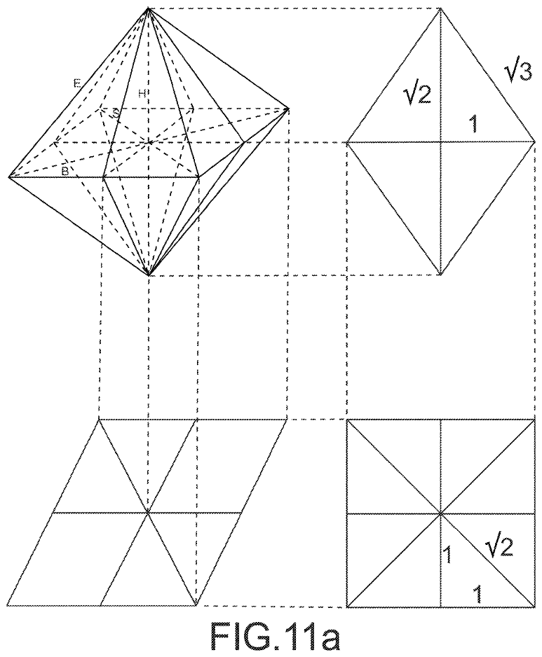

In Table 1, the column having the Symmetry “Diamond” corresponds to an embodiment in which the bodies (or puzzle pieces) of a single 16-body geometric art toy device can be pivoted to form an octahedron shape as shown in FIGS. 10a and 10b. However, three or more of those same 16-body geometric art toy devices cannot be connected together to form a symmetrical structure. FIG. 10a shows a diagram representing the three-dimensional diamond shape, as well as a side view and a top-down (or bottom up) view of the three-dimensional diamond shape, with indica representing the size dimensions of certain body edges. FIG. 10b shows a sheet pattern of a body (or puzzle piece) of the example in FIG. 10a, where the example in FIG. 10a includes sixteen bodies (or puzzle pieces) composed of eight mirror image pairs of bodies (or puzzle pieces), each body having the configuration, or a mirror image of the configuration, shown in FIG. 10b.

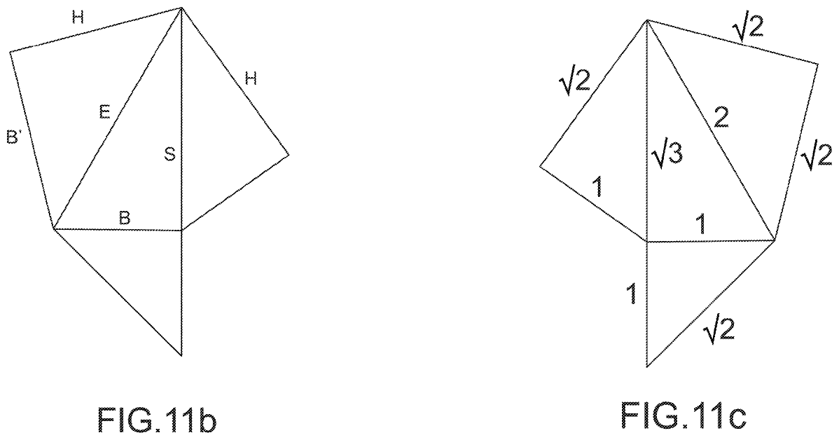

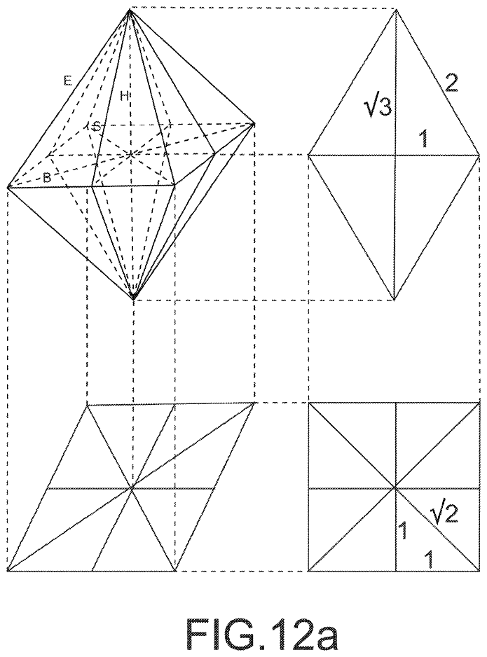

In Table 1, the column labeled “5” relates to an embodiment in which the bodies (or puzzle pieces) of a single 16-body geometric art toy device can be pivoted to form a substantially diamond shape having a true or close-to true symmetry as shown in FIGS. 11a and 11b, and in which five of those same 16-body geometric art toy devices can connect together to form a larger, substantially symmetrical structure. FIG. 11a shows a diagram representing the three-dimensional diamond shape, as well as a side view and a top-down (or bottom up) view of the three-dimensional diamond shape, with indica representing the size dimensions of certain body edges. FIG. 11b shows a sheet pattern of a body (or puzzle piece) of the example in FIG. 11a, where the example in FIG. 11a includes sixteen bodies (or puzzle pieces) composed of eight mirror image pairs of bodies (or puzzle pieces), each body having the configuration, or a mirror image of the configuration, shown in FIG. 11b.

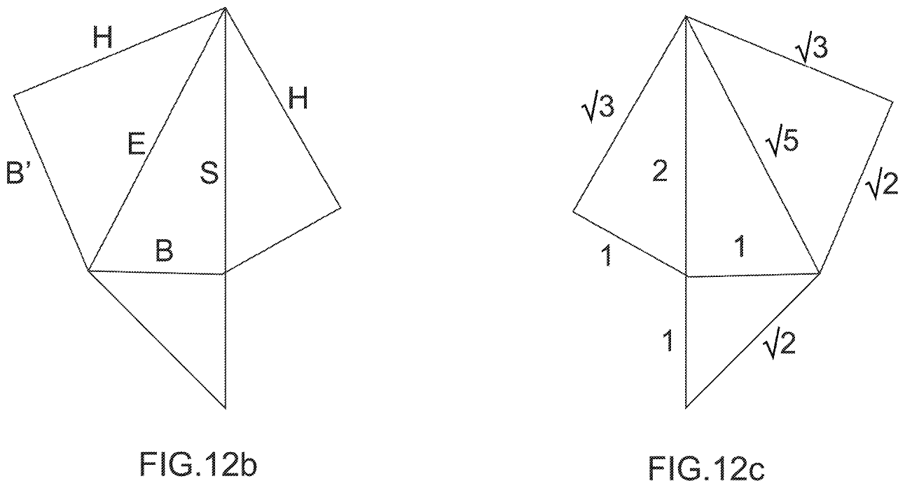

In Table 1, the column having the Symmetry “6” corresponds to an embodiment in which the bodies (or puzzle pieces) of a single 16-body geometric art toy device can be pivoted to form an octahedron having a substantially diamond shape with a somewhat elongated appearance (relative to the shape in FIG. 1), as shown in FIGS. 12a and 12b, and in which six of those same 16-body geometric art toy devices can connect together to form a larger, substantially symmetrical structure. FIG. 12a shows a diagram representing the three-dimensional diamond shape, as well as a side view and a top-down (or bottom up) view of the three-dimensional diamond shape, with indica representing the size dimensions of certain body edges. FIG. 12b shows a sheet pattern of a body (or puzzle piece) of the example in FIG. 12a, where the example in FIG. 12a includes sixteen bodies (or puzzle pieces) composed of eight mirror image pairs of bodies (or puzzle pieces), each body having the configuration, or a mirror image of the configuration, shown in FIG. 12b.

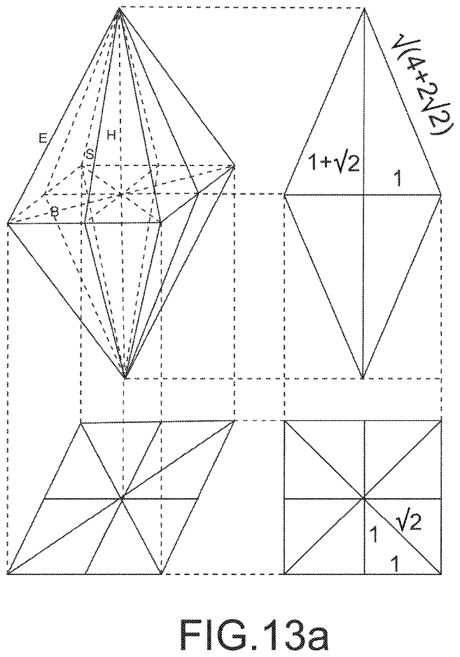

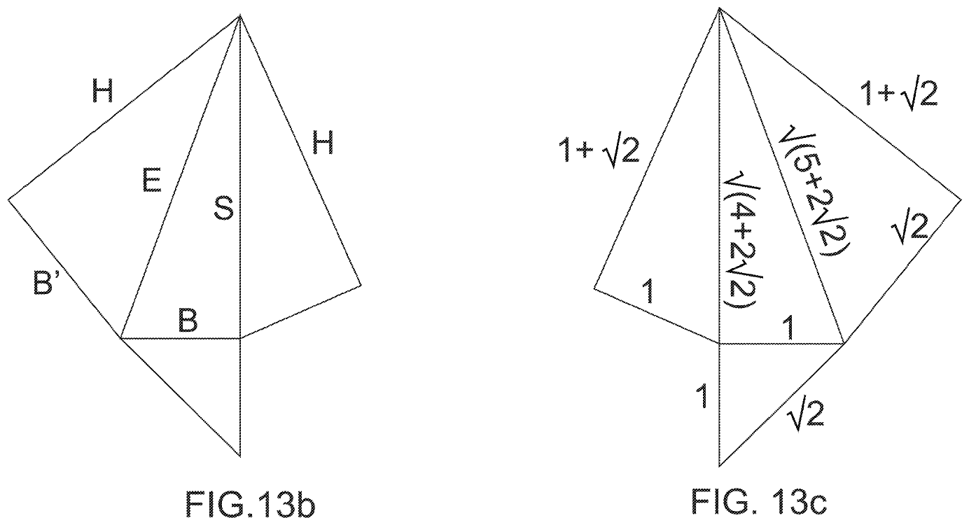

In Table 1, the column having the Symmetry “8” corresponds to an embodiment in which the bodies (or puzzle pieces) of a single 16-body geometric art toy device can be pivoted to form an octahedron having a substantially diamond shape with an elongated appearance (relative to the shape in FIG. 1), as shown in FIGS. 13a and 13b, and in which six of those same 16-body geometric art toy devices can connect together to form a larger, substantially symmetrical structure. FIG. 13a shows a diagram representing the three-dimensional diamond shape, as well as a side view and a top-down (or bottom up) view of the three-dimensional diamond shape, with indica representing the size dimensions of certain body edges. FIG. 13b shows a sheet pattern of a body (or puzzle piece) of the example in FIG. 13a, where the example in FIG. 13a includes sixteen bodies (or puzzle pieces) composed of eight mirror image pairs of bodies (or puzzle pieces), each body having the configuration, or a mirror image of the configuration, shown in FIG. 13b.

Some or all of the bodies (or puzzle pieces) in each of the above-described embodiments may include one or more magnets for holding (by magnetic force) the bodies (or puzzle pieces) in one or more configurations, including the substantially diamond shapes discussed above. In some embodiments, the magnets may be arranged such that, when the bodies (or puzzle pieces) of a sixteen-body device are arranged in a diamond shape as described herein, each side surface of each body (or puzzle piece) that engages and faces a side surface of another body (or puzzle piece) has a magnet with a magnetic pole facing an opposite magnetic pole (or magnetically attractable material) on the engaged or faced side surface of the other body (or puzzle piece). In some embodiments, when the bodies (or puzzle pieces) are arranged in a diamond shape as described herein, the outward facing surfaces of the bodies (or puzzle pieces) defining the diamond shape have a magnet or a magnetic pole facing outward to magnetically couple with a side surface of one or more other of the same sixteen-body devices that are also arranged in a diamond shape as described (or in another geometric shape) to form a different overall geometric shape. In certain embodiments, the number of magnets is minimized, to help reduce cost of the product.

Accordingly, an embodiment of a geometric art toy device described herein comprises a set of sixteen tetrahedron-shaped bodies (or puzzle pieces) that are linked together by hinge connections including a first hinge connection along an edge B of the base of each of the bodies (or puzzle pieces), and a second hinge connection along the longest edge E of each of the bodies (also referred to herein as the hypotenuse edge of each of those bodies), wherein each tetrahedron-shaped body (or puzzle piece) has dimensions as set forth in any one of the columns Table 1.

A further embodiment comprises a number N of such geometric art toy devices, wherein the number N corresponds to the number in the Symmetry row of one of the columns of Table 1.

A further embodiment comprises a plurality of magnets located within at least some of the tetrahedron-shaped body (or puzzle piece), to hold the tetrahedron-shaped bodies (or puzzle pieces) together in an octahedron shape.

Each of the tetrahedron-shaped bodies may be made or formed in any suitable manner including, but not limited to cutting a pattern from a sheet material corresponding to patterns shown in FIGS. 3a, 3b, 8b, 9b, 10b, 11b, 12b or 13b, and folding the cut pattern along the internal edges E, S and B. In other examples, the tetrahedron-shaped bodies may be made or formed by other suitable manufacturing methods including, but not limited to molding, machining, cutting, or the like. The hinge connections may be made by any suitable processes including, but not limited to adhering a flexible material onto hinged surfaces and across the hinge-connected edges B and E of adjacent tetrahedron-shaped bodies in the set of sixteen bodies, to form live hinges between adjacent bodies. The flexible material may comprise a sheet or layer of a paper, plastic or other flexible material, and may have design indicia on an outward facing surface of the sheet or layer of flexible material. In other examples, hinge structures may be formed in the edges B and E of each tetrahedron-shaped body.

What is claimed is:

1. A geometric art toy device comprising a set of sixteen tetrahedron-shaped bodies that are linked together by hinge connections, where:
each of the tetrahedron-shaped bodies has:
an edge E defining a longest-length edge of the tetrahedron-shaped body,
a base surface defining a first base edge B and a hypotenuse edge B′, and
a first side surface defining a further edge H and a second further edge S of the tetrahedron-shaped body;
the hinge connections include a first hinge connection along the first base edge B of the base of each of the bodies, and a second hinge connection along the edge E of each of the bodies; and
each tetrahedron-shaped body has dimensions as set forth in any one of the following combinations a-f, where l represents a single unit of length:
a. H=√(1/3), E=√(7/3), S=√(4/3), B=1, and B′=√2;
b. H=1, E=√3, S=√2, B=1, and B′=√2;
c. H=√2, E=2, S=√3, B=1, and B′=√2;
d. H=1.37638, E=1.97343, S=1.7013, B=1, and B′=√2;
e. H=√3, E=√5, S=2, B=1, and B′=√2; or
f. H=1+√2, E=√(4+2√2), S=√(5+2√2), B=1, and B′=√2.

2. The geometric art toy device of claim 1, wherein the base surface defines a second base edge that is perpendicular to the base edge B.

3. The geometric art toy device of claim 2, wherein the second base edge has the same length as the base edge B.

4. The geometric art toy device of claim 1, wherein each tetrahedron-shaped body has four right triangle-shaped side surfaces.

5. A geometric art toy system that comprises a number N of the geometric art toy devices as recited in claim 1, wherein the number N is greater than 1.

6. The geometric art toy system as recited in claim 5, wherein the dimensions of each tetrahedron-shaped body correspond to the dimensions in column a, and where the number N is 3.

7. The geometric art toy system as recited in claim 5, wherein the dimensions of each tetrahedron-shaped body correspond to the dimensions in column b, and where the number N is 4.

8. The geometric art toy system as recited in claim 5, wherein the dimensions of each tetrahedron-shaped body correspond to the dimensions in column d, and where the number N is 5.

9. The geometric art toy system as recited in claim 5, wherein the dimensions of each tetrahedron-shaped body correspond to the dimensions in column e, and where the number N is 6.

10. The geometric art toy system as recited in claim 5, wherein the dimensions of each tetrahedron-shaped body correspond to the dimensions in column f, and where the number N is 8.

11. The geometric art toy device as recited in claim 1, further including a plurality of magnets located within at least some of the tetrahedron-shaped bodies, to hold the tetrahedron-shaped bodies together in an octahedron shape.

12. The geometric art toy device as recited in claim 1, wherein the sixteen tetrahedron-shaped bodies include eight mirror image pairs of tetrahedron-shaped bodies.

13. The geometric art toy device as recited in claim 1, wherein each of the hinge connections comprises a live hinge formed of a sheet or layer of flexible material adhered to surfaces of adjacent tetrahedron-shaped bodies in the set.

14. A geometric art toy device comprising a set of sixteen tetrahedron-shaped bodies that are linked together by hinge connections, where:
each of the tetrahedron-shaped bodies has:
an edge E defining a longest-length edge of the tetrahedron-shaped body,
a base surface defining a first base edge B and a hypotenuse edge B′, and
a first side surface defining a further edge H and a second further edge S of the tetrahedron-shaped body;
the hinge connections include a first hinge connection along the first base edge B of the base of each of the bodies, and a second hinge connection along the edge E of each of the bodies; and
each tetrahedron-shaped body has the dimensions: H=√2, E=2, S=√3, B=1, and B′=√2.

15. The geometric art toy device of claim 14, wherein the base surface defines a second base edge that is perpendicular to the base edge B.

16. The geometric art toy device of claim 15, wherein the second base edge has the same length as the base edge B.

17. The geometric art toy device of claim 14, wherein each tetrahedron-shaped body has four right triangle-shaped side surfaces.

18. The geometric art toy device as recited in claim 14, further including a plurality of magnets located within at least some of the tetrahedron-shaped bodies, to hold the tetrahedron-shaped bodies together in an octahedron shape.

19. The geometric art toy device as recited in claim 14, wherein the sixteen tetrahedron-shaped bodies include eight mirror image pairs of tetrahedron-shaped bodies.

20. The geometric art toy device as recited in claim 14, wherein each of the hinge connections comprises a live hinge formed of a sheet or layer of flexible material adhered to surfaces of adjacent tetrahedron-shaped bodies in the set.
